(19) United States
(12) Patent Application Publication
(10) Pub. No.: US 2024/0223498 A1
(43) Pub. Date: Jul. 4, 2024

(54) NETWORK CONFIGURATION FOR POLICY COMPLIANT SPANNING TREE

(71) Applicant: Calix, Inc., San Jose, CA (US)

(72) Inventors: Daniel J. Sills, Moss Beach, CA (US); Gregg C. Heikkinen, Tony, WI (US); Tim Ethen, Maple Grove, MN (US); Duane M. Butler, Anoka, MN (US)

(21) Appl. No.: 18/148,734

(22) Filed: Dec. 30, 2022

(51) Int. Cl. H04L 45/48; H04L 45/302; H04L 45/58

(52) U.S. Cl. CPC H04L 45/48; H04L 45/302; H04L 45/58

(57) ABSTRACT

A communication system memory configured to store a network policy, and a network controller, implemented in circuitry, coupled to the memory and configured to: determine a first set of communication paths established by implementation of a spanning tree protocol, in a first instance, in a network of one or more satellite devices, determine that a second set of communication paths is more aligned with the network policy than the first set of communication paths, and output, based on the determination that the second set of communication paths is more aligned with the network policy than the first set of communication paths, one or more commands to modify usage of at least one communication port of at least one satellite device to cause a second instance of implementation of the spanning tree protocol to establish the second set of communication paths in the network.

### TECHNICAL FIELD

This disclosure relates to communication systems, and more particularly, communication between devices in a spanning tree.

### BACKGROUND

A communication system includes paths that allow devices to communication between one another. In one way to define the paths is in accordance with a spanning tree protocol. The spanning tree protocol is layer 2 network protocol used to prevent looping within a network topology.

### BRIEF DESCRIPTION OF DRAWINGS

FIGS. 1A and 1B are block diagrams illustrating example communication systems, in accordance with one or more aspects of this disclosure.

FIG. 2 is a block diagram illustrating an example of a network controller and memory, in accordance with one or more aspects of this disclosure.

FIG. 3 is a block diagram illustrating an example a modified usage of at least one communication port for spanning tree protocol updating.

FIG. 4 is a block diagram illustrating another example a modified usage of at least one communication port for spanning tree protocol updating.

FIG. 5 is a block diagram illustrating another example a modified usage of at least one communication port for spanning tree protocol updating.

FIG. 6 is a flowchart illustrating example techniques, in accordance with one or more aspects of this disclosure.

### DETAILED DESCRIPTION

A communication system (e.g., network) includes one or more access points, such as a gateway device (e.g., router) and one or more satellite devices. A gateway device may be referred to as a gateway node, and a satellite device may be referred to as a satellite node. The one or more satellite devices may be coupled to respective client devices, also called stations or STAs. For communication, each client device may be associated with one of the access points. For instance, in one example network topology, a first access point may be a gateway device that couples to a wide area network (WAN) such as the Internet. The first access point may communicate with a plurality of other access points (e.g., satellite devices within a premises), and the plurality of satellite devices may communicate with one or more client devices (e.g., computers, smartphones, tablets, smart watches, Internet of Things (IOT) devices, etc.). The satellite devices may be routers, extenders, repeaters, and the like.

Accordingly, residential-scale networks (e.g., local area network (LAN)) utilize a gateway device for connecting to the Internet, and one or more satellite devices located throughout the site being served. Communication paths between the gateway and satellite devices include wired technologies like Ethernet, powerline, etc. but also wireless technologies, such as wireless communication compliant with the IEEE 802.11 standards.

In one or more examples, a network controller may be configured to determine communication paths that create a network topology that aligns, to the greatest extent possible, with a network policy. The term “network controller” refers, for example, to one or more processors on a particular device, such as the gateway device, or processors distributed across different devices and/or in a cloud environment. For instance, the network controller may be configured to implement a network controller process. This network controller process may be distributed across different components, such as processor(s) of the gateway device, across the processors(s) of the gateway device and the satellite devices, across other processors, such as in a router, or in a cloud environment.

One example way to determine communication paths to create a network topology is implementing a spanning tree protocol (STP) (e.g., as defined by the IEEE 802.1 standard). The implementation of the STP may be distributed across the gateway devices and satellite devices, but the techniques are not limited.

The implementation of the STP is to prevent loops due to misconfiguration. For example, it may be possible for there to be multiple communication paths between two satellite devices, as one example. In some cases, if there is a broadcast of data, a first satellite device may broadcast the data to a second satellite device on a first communication path, and then the second satellite device may broadcast the data back to the first satellite device on a second communication path creating an unwanted loop that can cause latency in the network.

Implementation of the STP may ensure that there is not looping in the network topology of network. However, there may be possibility that the network topology is inconsistent with the network policy. That is, the topology of the network may be the one selected by the STP, but this topology may not be the one that most aligns with the network policy.

This disclosure describes example techniques of the network controller (e.g., executing the network controller process) outputting one or more commands (e.g., to at least one satellite device or the gateway device) to modify usage of at least one communication port of at least one satellite device. The modification of the usage of the at least one communication port may cause the STP implementation to determine a network topology that is then consistent with the network policy.

As an example, the network controller may determine a first set of communication paths established by implementation of a spanning tree protocol, in a first instance, in a network of one or more satellite devices. For example, gateway device and the satellite devices together may implement the spanning tree protocol (e.g., in a distributed manner), and the result may be the spanning tree protocol establishing a first set of communication paths (e.g., a first spanning tree). The network controller may receive information about which ports on the gateway device and/or satellite devices are being used for the first set of communication paths, and based on such information may determine the first set of communication paths, which have been established by implementation of a spanning tree protocol, in a first instance, in a network of one or more satellite devices.

The network controller may determine that a second set of communication paths is more aligned with the network policy than the first set of communication paths. For instance, the network controller may determine additional sets of communication paths (e.g., additional spanning trees), and may determine that there is an additional set of communication paths in the additional sets of communication paths that is more aligned with the network policy than the first set of communication paths. This additional sets of communication paths is the second set of communication paths.

The network controller may output, based on the determination that the second set of communication paths is more aligned with the network policy than the first set of communication paths, one or more commands to modify usage of at least one communication port of at least one satellite device. In this way, by modifying usage of the at least one communication port, the result may be to cause a second instance of implementation of the spanning tree protocol to establish the second set of communication paths in the network.

For instance, the network controller may determine one or more additional sets of communication paths (e.g., additional spanning trees) in addition to the first set of communication path (e.g., the first spanning tree), and determine policy alignment values of the one or more additional sets of communication paths based on the network policy. The policy alignment values may be indicative of how much each of the additional sets of communication paths align with the network policy. The network controller may select an additional set of communication paths from the one or more additional sets of communication paths based on the policy alignment values. In this example, the selected additional set of communication paths is the second set of communication paths (e.g., the additional set of communication paths that aligns to the greatest extent possible with the network policy).

The network controller may determine usage of the at least one communication port of the at least one satellite device that would result in the spanning tree protocol establishing the second set of communication paths (e.g., so that the resulting network topology aligns with the network policy). The network controller is configured to output the one or more commands based on the determined usage of the at least one communication port.

In this manner, the network controller may “trick” the STP implementation into selecting the network topology that most aligns with the network policy. That is, the network controller may select usage of the communication ports such that an undesired communication port (e.g., usage of which leads to communication paths that are inconsistent with network policy) is not the communication port that the STP implementation would select. Accordingly, without modifying weights or otherwise controlling the operation of the STP implementation, the resulting network topology (e.g., having the second set of communication paths) may most align with the network policy. For instance, in one or more examples, how the STP is implemented may not change. Rather, the usage of the communication ports may be adjusted so that the STP implementation automatically ends up selecting a network topology (e.g., communication paths between satellite devices) that aligns with the network policy.

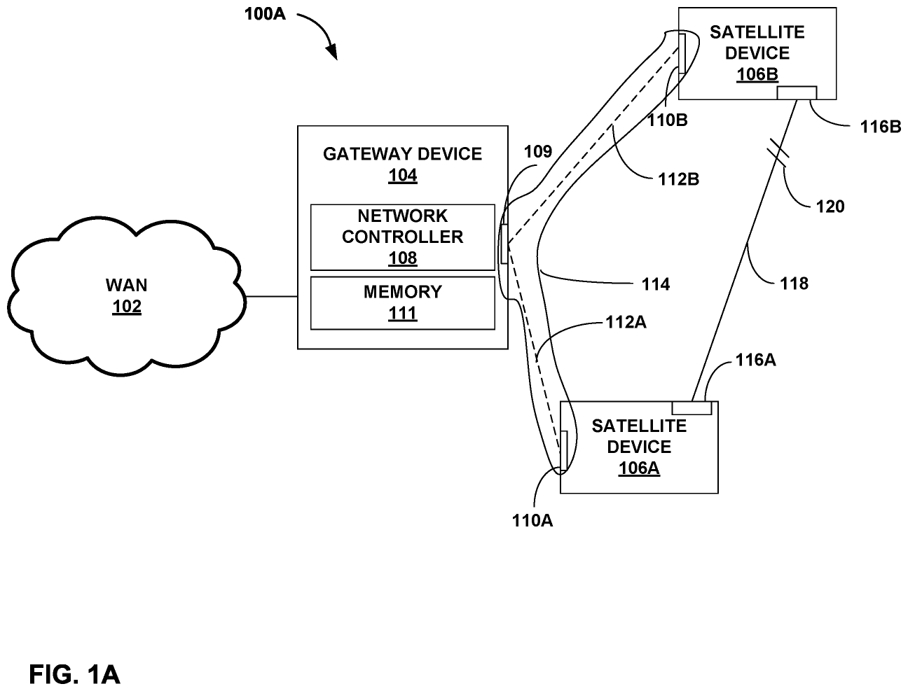

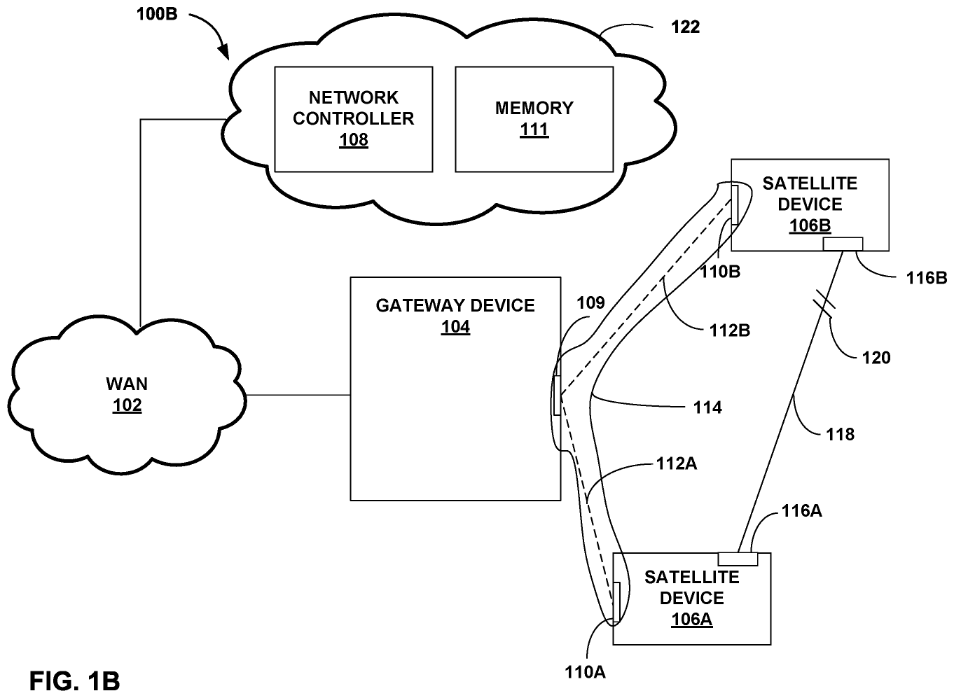

FIGS. 1A and 1B are block diagrams illustrating example communication systems, in accordance with one or more aspects of this disclosure. For instance, FIGS. 1A and 1B illustrate communication systems 100A and 100B, respectively. Communication systems 100A and 100B may be multi-node channelized wireless and wired networks, such as wireless networks that operate in accordance with the Wi-Fi protocols and wired networks that operate in accordance with various wired network protocols. In some examples, communication systems 100A and 100B form a local area network (LAN).

Communication systems 100A and 100B may be networks within a premise, such as a home, school, business, etc. However, the example techniques are not limited to requiring communication systems 100A and 100B be located within a single premise, and may extend across multiple buildings.

Communication systems 100A and 100B include gateway device 104 (also called gateway node 104) and satellite devices 106A and 106B (also called satellite node 106A and 106B or satellite devices 106). For ease of illustration and description, communication systems 100A and 100B are shown with two satellite devices 106. However, the techniques are not so limited. There may be two or more satellite devices 106. Each of the two or more satellite devices 106 may communicate with one or more client devices.

Gateway device 104 and satellite devices 106 may be networking hardware devices that provide wireless or wired connectivity to client devices. Gateway device 104 and satellite devices 106 may be considered as access points. Examples of gateway device 104 and satellite devices 106 include routers, extenders, repeaters, and the like. Examples of the client devices include subscriber devices that can communicate wirelessly or with wire such as computers, smartphones, smartwatches, tablet computing devices, Internet-of-Things (IOT) devices, and the like.

As illustrated in FIGS. 1A and 1B, communication systems 100A and 100B may communicate with WAN 102. One example of WAN 102 is the Internet. For instance, as illustrated in FIGS. 1A and 1B, gateway device 104 (e.g., a first access point) provides access to WAN 102 to other access points (e.g., satellite devices 106) and client devices of satellite devices 106. In FIGS. 1A and 1B, gateway device 104 may be considered as a gateway access point (e.g., AP-G). Satellite devices 106 may be considered as a repeater access points (e.g., AP-R).

There may be additional examples of communication systems than those illustrated in FIGS. 1A and 1B. In some examples, a router provides access to WAN 102 for different access points (e.g., gateway device 104 and satellite devices 106). The router may be coupled to gateway device 104 and/or satellite devices 106 through a cabled (e.g., wired) connection, such as fiber optic cable, Ethernet cable, twisted pair cable, coaxial cables, etc.).

FIGS. 1A and 1B illustrate network controller 108, which may be one or more processors, and memory 111. As described in more detail, network controller 108 (e.g., together with memory 111) may be configured to perform the example techniques described in this disclosure. Examples of network controller 108 include one or more digital signal processors (DSPs), general purpose microprocessors, application specific integrated circuits (ASICs), field programmable logic arrays (FPGAs), or other equivalent integrated or discrete logic circuitry. Accordingly, the term “processor” or “controller” as used herein may refer to any of the foregoing structure or any other structure suitable for implementation of the techniques described herein. Also, the techniques could be fully implemented in one or more circuits or logic elements (e.g., such as in an integrated circuit (IC) or a set of ICs). Examples of memory 111 include RAM, ROM, EEPROM, optical disk storage, magnetic disk storage, flash memory, and the like.

In the example of FIG. 1A, network controller 108 and memory 111 may be part of gateway device 104. In the example of FIG. 1B, network controller 108 and memory 111 may be part of cloud computing environment 122, e.g., within one or more servers. Cloud computing environment 122 may provide storage and computing power for wireless communication system 100B. For instance, network controller 108 and memory 111 may be distributed across cloud computing environment 122.

Network controller 108 and memory 111 are illustrated in FIGS. 1A and 1B for ease of illustration only. In some examples, network controller 108 and memory 111 may also be distributed across gateway device 104, satellite devices 106, cloud computing environment 122, or some other component within a premise.

In FIGS. 1A and 1B, gateway device 104 and satellite devices 106 form a network having a network topology. For instance, gateway device 104 includes communication port for wireless communication with satellite device 106B via communication port 110B, and with satellite device 106A via communication port 110A. In one or more examples, communication ports 110A and 110B may be considered as a 802.11 non-access-point (non-AP) station interfaces because satellite devices 106A and 106B, respectively, use communication ports 110A and 110B to establish an association with gateway device 104.

As illustrated, communication path 112B forms the wireless communication path between communication port 109 and communication port 110B of satellite device 106B, and communication path 112A forms the wireless communication path between communication port 109 and communication port 110A of satellite device 106A. Communication port 109 may be considered as an 802.11 access-point (AP) interface because communication port 109 is the communication port used by satellite devices 106A and 106B to associate with gateway device 104. In the example of FIGS. 1A and 1B, communication paths 112A and 112B may be part of a trunking basic service set (BSS) 114 that emanated by gateway device 104. As one example, the physical layer (PHY) rate of communication path 112B may be 500 Mbps, and the PHY rate of communication path 112A may be 1 Gbps.

In some examples, there may also be wired connections between satellite devices 106. For example, as illustrated in FIGS. 1A and 1B, there may be a wired communication path 118 between satellite device 106A using communication port 116A and satellite device 106B using communication port 116B. However, as described in more detail, there may be a possibility that wired communication path 118 is blocked (e.g., not in use), as illustrated by blocking connection 120.

For example, to ensure proper Wi-Fi coverage, residential-scale networks (e.g., such as those of FIGS. 1A and 1B) utilize gateway device 104 and one or more satellite devices 106 located remote from each other and the gateway device 104. Communication paths (e.g., communication paths 112A, 112B, and 118) between gateway 104 and satellite devices 106 may be based on wired technologies like Ethernet, powerline, etc. but also wireless technologies like IEEE 802.11. In one or more examples, gateway device 104 and one or more satellite devices 106 can simultaneously support an 802.11 access point (AP) interface allowing zero or more peer nodes to associate to it and an 802.11 non-access-point (non-AP) station interface, allowing it to associate to the AP function of a peer node. As illustrated in FIGS. 1A and 1B, the aforementioned AP interfaces each manifest a trunking BSS 114.

The term 802.11 AP interface corresponds to a definition of access point in the 802.11 standards. The term 802.11 non-AP station interface corresponds to a definition of non-AP STA in the 802.11 standards. A non-AP STA is a station (STA) that is not contained within an access point (AP). In general, an 802.11 AP interface of a current satellite device 106 allows another satellite device 106 to associate with the current satellite device 106. An 802.11 non-AP station interface of a current satellite device 106 allows the current satellite device 106 to associate with another satellite device 106 or the gateway device 104.

In one or more examples, one or more of gateway device 104 and satellite devices 106A and 106B (e.g., in a distributed manner) may be configured to implement a spanning tree protocol (STP). The implementation of the spanning tree protocol establishes a network topology that minimizes loops.

STP implementation is useful for promptly detecting and pruning loops. A loop in the network topology may be when data from one device to another can loop back on a different path creating a perpetual transmission and reception of data, creating high latency. In some examples, when STP is implemented, gateway device 104 is designed to be the STP-plane root; however, the example techniques are not so limited.

The communication path between each satellite device 106 and the gateway/root device 106 chosen by the STP implementation is the one that has the lowest Root Path Cost, where the latter equals the sum of the Root Path Cost of each interface on the path that receives frames transmitted by the root that has the lowest such sum across all possible paths. If two communication paths are tied, various tie-break logic is employed to select the winning communication path.

In the example of FIGS. 1A and 1B, network controller 108 may determine a first set of communication paths (e.g., a first spanning tree without looping) established by implementation of a spanning tree protocol, in a first instance, in network 100A or 100B of one or more satellite devices 106A and 106B. For instance, network controller 108 may receive information indicative of a manner in which satellite devices 106A and 106B are communicating with one another as established by the implementation of the spanning tree protocol, and may determine the a first set of communication paths resulting from the implementation of the spanning tree protocol.

For instance, assume that communication path 118 is not available. In this case, the network topology appears as a tree with communication paths 112A and 112B being branches, and there is no looping in the communication paths 112A and 112B such that data communicated from gateway device 104 and satellite devices 106 can loop.

The Root Path Cost assigned to a trunking interface (e.g., communication ports 109, 110A, and 110B) ought to reflect the capacity of the communication path to which communication ports connect. For example, the Root Path Cost associated to communication path 112A may reflect the capacity of communication path 112A through communication ports 109 and 110A, and the Root Path Cost associated to communication path 112B may reflect the capacity of communication path 112B through communication ports 109 and 110B.

Independent of how capacity is defined, in some examples, the assignment of the proper Root Path Cost to each non-AP station interfaces (e.g., each one of communication ports 109, 110A, and 110B) is complicated by several factors such as the characteristics of each wireless communication path 112A and 112B fluctuating over long and short time scales. This may be because the maximum data rate between gateway device 104 and satellite devices 106 of trunking BSS 114 is a function of RF transmit power of communication port 110A and 110B which varies by RF channel due to legal restrictions and implementation considerations. Also, the maximum capacity between gateway device 104 and satellite devices 106 of trunking BSS 114 is a function of provisioned RF channel BW and which 802.11 standard is employed, and both of these are subject to modification by the user and/or the network controller process.

Accordingly, by implementing STP, the resulting communication paths 112A and 112B do not loop. However, network controller 108 may need to determine whether the network topology (e.g., as defined by the communication paths between gateway device 104 and satellite devices 106, including communication paths 112A and 112B) is consistent with a network policy. Stated another way, a responsibility of network controller 108 is to ensure that each node (e.g., gateway device 104 and satellite devices 106) that are members of a trunking BSS 114 (e.g., based on communication paths 112A and 112B belonging to trunking BSS 114) communicate with each other in a way that aligns with the network policy. Examples of such network policies include: maximizing throughput between the gateway device 104 and Wi-Fi client devices of each one of satellite devices 106, maximizing throughput between the gateway device 104 and 5 GHz client devices of each one of satellite devices 106, etc.

One way to achieve a network topology that aligns with the network policy is to adjust parameters used for implementing the STP (e.g., configure or fine-tune Root Path Costs or native modifications to the STP). However, such techniques may be complicated and susceptible to user error.

This disclosure describes example techniques to create a network topology that aligns with the network policy such as without modifying parameters of the spanning tree protocol, as one example. It may be possible to modify parameters of the spanning tree protocol in addition to performing the example techniques described in this disclosure. That is, the example techniques may obviate the need to modify parameters of the spanning tree protocol, or reduce the number of parameters that need to be modified.

For instance, the components (e.g., gateway device 104 and satellite devices 106A and 106B) may implement a spanning tree protocol in a first instance to establish a first set of communication paths (e.g., communication paths 112A and 112B), that do not loop, in a network of one or more satellite devices 106. Network controller 108 may determine the first set of communication paths established by implementation of the spanning tree protocol, in the first instance, in a network 100A or 100B of one or more satellite devices 106A and 106B.

Network controller 108 may determine that a second set of communication paths is more aligned with the network policy than the first set of communication paths (e.g., the first set of communication paths are inconsistent or less consistent with the network policy than another communication path). For instance, the following describes an example case where network controller 108 may determine that the second set of communication paths is more aligned with the network policy than the first set of communication paths.

In the example of FIGS. 1A and 1B, the PHY rate of communication path 110A (e.g., 802.11 trunk between gateway device 104 and satellite device 106A) may be 1 Gbps because satellite device 106A may be relatively close to gateway device 104. The PHY rate of communication path 110B (e.g., 802.11 trunk between gateway device 104 and satellite device 106B) may be 500 Mbps because satellite device 106B may be relatively distant to gateway device 104.

Due to the lower PHY rate of 500 Mbps, client devices (e.g., stations or STAs) connected to satellite 106B experience a low throughput from WAN 102. In this case, the user of the network may choose to establish a 2.5 Gbps Ethernet point to point link in the form of communication path 118 between communication port 116A of satellite device 106A and communication port 116B of satellite device 106B. This way, the slowest PHY rate to satellite device 106B would be 1 Gbps (i.e., from gateway device 104 to satellite device 106A is 1 Gbps over wireless communication path 112A, but from satellite device 106A to satellite device 106B is 2.5 Gbps over Ethernet communication path 118). However, assuming the STP-plane Root Path Cost for all non-AP station interfaces on all nodes (e.g., on all satellite devices 106) have the same value then, the STP implementation will block communication path 118 on either satellite device 106A or satellite device 106B and thereby deny the improvements sought by the user. In FIGS. 1A and 1B, blocking connection 120 shows that communication port 116B of satellite device 106B is being blocked for case of illustration.

In one or more examples, network controller 108 may be configured to identify feasible (e.g., all or subset) spanning trees in addition to the one determined by STP implementation. In other words, network controller 108 may determine one or more additional sets of communication paths in addition to the first set of communication paths (e.g., the communication paths determined by the STP implementation).

Network controller 108 may determine policy alignment values of the one or more additional sets of communication paths and the first set of communication paths based on the network policy. For example, assume that the network policy is to maximize throughput between gateway device 104 and satellite devices 106. In this example, the policy alignment values may be indicative of an assumed throughput of each of the additional communication paths determined by network controller 108 and the first set of communication paths determined by STP implementation.

Network controller 108 may be configured to determine that the first set of communication paths (e.g., ones determined by STP implementation) are inconsistent with the network policy based on the policy alignment values. For instance, network controller 108 may determine that a second set of communication paths is more aligned with the network policy than the first set of communication paths.

As an example, if there are other communication paths, without looping, that provide higher throughput, then network controller 108 may determine that the first set of communication paths are inconsistent with the network policy. Stated another way, if there is a second set of communication paths (e.g., a second spanning tree) that provides higher throughput than the first set of communication paths, then network controller 108 may determine that the second set of communication paths is more aligned with the network policy than the first set of communication paths. In this example, the second set of communication paths is one of the additional sets of communication paths that network controller 108 evaluated.

Network controller 108 may output, based on the determination that the second set of communication paths is more aligned with the network policy than the first set of communication paths, one or more commands to modify usage of at least one communication port of at least one satellite device. As described in more detail, modifying usage of at least one communication port of at least one satellite device may cause a second instance of implementation of the spanning tree protocol to establish the second set of communication paths in the network (e.g., the one of the additional sets of communication paths that is more aligned with the network policy than the first set of communication paths).

For instance, network controller 108 may output one or more commands to modify the usage of communication port 110B of satellite device 106B so that satellite device 106B does not communicate directly with gateway device 104. In this case, there may only be one communication path between gateway device 104 and satellite device 106B. The various components (e.g., gateway device 104 and satellite devices 106A and 106B) may implement the spanning tree protocol in a second instance to establish the second set of communication paths in the network based on the modified usage of the communication port. For instance, in a second instance of the spanning tree protocol, because communication path 112B is not available, the second instance of the implementation of the spanning tree protocol may automatically determine that communication path 118 between communication ports 116A and 116B should be available, and remove blocking connection 120.

For instance, as described above, network controller 108 may determine additional sets of communication paths in addition to the one determined by implementing the first instance of the STP. Network controller 108 may select an additional set of communication paths from the one or more additional sets of communication paths based on the policy alignment values. The selected additional set of communication paths may be the communication path that most closely aligns to the network policy. For instance, as described above, the second set of communication paths may be one that aligns closest to the network policy. Accordingly, the selected additional set of communication paths is the second set of communication paths.

In one or more examples, network controller 108 may determine which communication path aligns with the network policy. However, rather than directly setting up the communication path that aligns with the network policy, network controller 108 may determine usage of the at least one communication port of the at least one satellite device that would result in the spanning tree protocol establishing the second set of communication paths. That is, by modifying the usage of communication port 110B so that communication port 110B is no longer communicating with gateway device 104, network controller 108 may “trick” the STP implementation into allowing satellite device 106A and satellite device 106B to communicate via communication path 118 (e.g., wired communication path 118) through communication ports 116A and 116B.

Network controller 108 may output the one or more commands based on the determined usage of the at least one communication port (e.g., communication port 110B). Examples of the one or more commands that network controller 108 may output are described in more detail below that would cause the STP implementation to automatically select the communication paths (e.g., the network topology) that align to the network policy (e.g., the second set of communication paths).

In some examples, even if there are communication paths that better align with the network policy, network controller 108 may determine that selecting another communication path does not provide sufficient benefit. For instance, there may be temporary disruption when switching communication paths, and the benefits of switching communication paths may not be greater than the cost of disruption. In some cases, there may be some level of uncertainty in determining the policy alignment values, and reliance on the policy alignment values for marginal misalignment from the network policy may not result in better alignment to the network policy due to the uncertainty in the policy alignment values.

Accordingly, in some examples, to determine that the second set of communication paths are more aligned with the network policy than the first set of communication paths, the network controller 108 may be configured to determine that the second set of communication paths are more aligned with the network policy by a sufficient threshold than the first set of communication paths. This sufficient threshold may be a numerical value, as one example. For instance, the policy alignment value of the second set of communication paths should be more than 2% closer to the network policy than the policy alignment value of the first set of communication paths. Other ways of assigning a sufficient threshold are possible, and the techniques are not limited. Network controller 108 may output, based on the determination that the second set of communication paths is sufficiently more aligned (e.g., more than the sufficient threshold) with the network policy than the first set of communication paths, the one or more commands to modify usage of at least one communication port of at least one satellite device to cause a second instance of implementation of the spanning tree protocol to establish the second set of communication paths in the network.

In the example of FIGS. 1A and 1B, network controller 108 may have taken the following actions to cause communication path 118 to be utilized. Once the Ethernet link (e.g., communication path 118) is added, network controller 108 may determine the following spanning trees are feasible:
a. current tree without communication path 118.
b. alternate tree 1: satellite 106A subtends wirelessly from gateway device 104 and satellite 106B subtends wirelessly from satellite 106A.
c. alternate tree 2: satellite device 106B subtends wirelessly from gateway device 104 and satellite device 106A subtends wirelessly from satellite device 106B.
d. alternate tree 3: satellite device 106A subtends wirelessly from gateway device 104 and satellite device 106B subtends with wired connection from satellite device 106A.
c. alternate tree 4: satellite device 106B subtends wirelessly from gateway device 104 and satellite device 106A subtends with wired connection from satellite device 106B.

Network controller 108 may determine policy alignment values for each of the above example trees. That is, network controller 108 may characterize the extent to which each spanning tree aligns with the network policy. For this example, assume that the network policy is: maximize the rate at which the node (e.g., satellite device 106A or 106B) can receive traffic from WAN 102 in the absence of congestion. Accordingly, network controller 108 may determine that alternate tree 3 most aligns with the network policy. For instance, the throughput to both satellite device 106A and satellite device 106B is highest in alternate tree 3, and is therefore the winner. In alternate tree 3, the slowest throughput is 1 Gbps, which may be greater than the throughput to satellite device 106B in of the other alternate trees including the spanning tree determined by the first instance of implantation of the STP.

Network controller 108 may then take actions to manifest alternate tree 3. That is, network controller 108 may output one or more commands (e.g., to at least one satellite device, such as satellite device 106B or gateway device 104) to modify usage of at least one communication port (e.g., communication port 110B) of at least one satellite device 106B. In this example, communication port 110 was used for a communication path (e.g., communication path 112A) of the first set of communication paths (e.g., the communication paths selected by the first instance of the STP implementation).

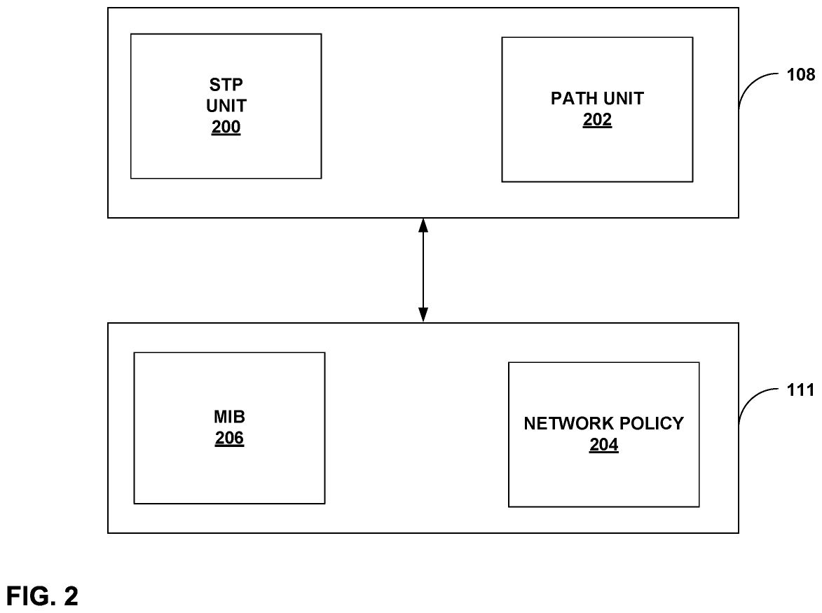

FIG. 2 is a block diagram illustrating an example of a network controller and memory, in accordance with one or more aspects of this disclosure. Network controller 108 and/or memory 111 may be distributed across the various components of systems 100A and 100B or may be located within one of the components of systems 100A and 100B.

As an example, FIG. 2 illustrates network controller 108 as including STP unit 200 and path unit 202, and memory 111 as including management information base (MIB) 206 and network policy 204. As described in more detail, MIB 206 may be information that is available from different satellite devices 106.

STP unit 200 and path unit 202 may be implemented in hardware and/or software. When implemented in software, memory 111 may store the object or source code for STP unit 200 and path unit 202. Network controller 108 may access the object or source code, and execute (after compiling if needed) STP unit 200 and path unit 202. As one example, path unit 202 may be part of an operating system that executes on network controller 108, and performs the various operations described in this disclosure.

STP unit 200 may be configured to determine a first set of communication paths (e.g., communication paths 112A and 112B) established by implementation of a spanning tree protocol, in a first instance, in a network of one or more satellite devices 106A and 106B. For example, the implementation of the spanning tree protocol may be distributed, and STP unit 200 may determine the results from the STP implementation. In general, STP unit 200 may be configured to facilitate the STP implementation such as receiving information of the set of communication paths that resulted from implementation of the spanning tree protocol, causing the STP to be implemented, etc.

As described above, the spanning tree protocol is a well-known protocol established in the 802.1 standard used to ensure that a network topology does not include data looping. This disclosure describes example techniques that leverage the capabilities of the spanning tree protocol to achieve a desired network policy, like network policy 204, without any or minimal modifications to parameters of the spanning tree protocol.

Path unit 202 may determine that the first set of communication paths are inconsistent with the network policy 204. For instance, path unit 202 may determine that a second set of communication paths is more aligned with the network policy than the first set of communication paths.

Path unit 202 may receive, from STP unit 200, information indicative of the first set of communication paths resulting from the implementation of the STP. Path unit 202 may determine one or more additional sets of communication paths in addition to the first set of communication paths. That is, path unit 202 may identify all feasible rosters of every trunking BSS (e.g., identify which satellites 106 can be members of which trunking BSSs). Stated another way, path unit 202 may identify all feasible spanning trees in addition to the one presently enforced by STP. For instance, path unit 202 determines the set of trunking BSSs each satellite 106 could conceivably join. Example ways to determine the feasible paths is described in more detail below. Also, to determine the additional sets of communication paths, path unit 202 may emulate a spanning tree protocol. For instance, path unit 202 may determine the additional sets of communication paths where none of the additional sets of communication paths loop or otherwise violate the spanning tree protocol. In other words, the additional sets of communication paths are valid spanning trees that could conceivably be selected by implementation of a spanning tree protocol if the Root Path Costs are the minimal Root Path Costs.

Path unit 202 may determine policy alignment values of the one or more additional sets of communication paths and the first set of communication paths based on the network policy 204. The additional sets of communication paths includes the second set of communication paths that may be more aligned to network policy 204. For example, to determine that the second set of communication paths is more aligned with the network policy 204 than the first set of communication paths, the network controller 108 may be configured to compare the respective policy alignment values of the one or more additional sets of communication paths, and determine that the second set of communication paths, which is one of the one or more additional sets of communication paths, is more aligned with the network policy 204 than the first set of communication paths based on the comparison.

For instance, path unit 202 may characterize the extent to which the first set of communication paths (e.g., one determined from STP implementation) and all the feasible alternatives (e.g., the one or more additional sets of communication paths) align with network policy 204. Stated another way, path unit 202 may characterize the extent to which the presently enforced spanning tree and all the feasible alternatives align with network policy 204. For instance, path unit 202 may determine various characteristics (e.g., max feasible PHY rate, interference burden, etc.) of all latent communication paths, where a latent communication path is a communication path that would come into existence if a satellite device not currently associated to another satellite device were to associate to the trunking BSS of that satellite device. That is, path unit 202 may determine the various characteristics of the one or more additional sets of communication paths (e.g., additional spanning trees).

As an example, path unit 202 may determine a first policy alignment value for the first set of communication paths (e.g., as determined from STP). The first policy alignment value may be indicative of how close the various characteristics of the first set of communication paths is to network policy 204. Path unit 202 may determine a second policy alignment value for one of the additional sets of communication paths (e.g., different from STP). The second policy alignment value may be indicative of how close the various characteristics of the additional set of communication paths is to network policy 204. Path unit 202 may repeat such operations for all or a subset of the additional sets of communication paths.

Path unit 202 may determine which of the policy alignment values is associated with the set of communication paths that most aligns to network policy 204. In the above examples, the second set of communication paths may most align to network policy 204.

If the set of communication paths that most aligns to network policy 204 (e.g., the second set of communication paths) is not the first set of communication paths (e.g., one selected by STP), path unit 202 may determine that the first set of communication paths is inconsistent with the network policy 204. That is, path unit 202 may determine that the second set of communication paths is more aligned with the network policy 204 than the first set of communication paths. For instance, path unit 202 may compare the respective policy alignment values of the one or more additional sets of communication paths, and determine that the second set of communication paths, which is one of the one or more additional sets of communication paths, is more aligned with the network policy than the first set of communication paths based on the comparison.

In some examples, path unit 202 may determine that the first set of communication paths is inconsistent with the network policy 204 if the first set of communication paths is inconsistent with the network policy 204 by a sufficient threshold. For example, to determine that the second set of communication paths is more aligned with the network policy 204 than the first set of communication paths, path unit 202 may be configured to determine that the second set of communication paths are more aligned with the network policy 204 by a sufficient threshold than the first set of communication paths. That is, even if there is another set of communication paths that aligns better with network policy 204, if the difference in the amount of alignment between this other set of communication paths and the first set of communication paths is less than a sufficient threshold, path unit 202 may not take further action to update the communication paths used by satellites 106.

However, if determined that one of the additional set of communication paths is more aligned with the network policy 204 than the first set of communication paths, path unit 202 may identify which one of the additional sets of communication paths most-closely aligns with network policy 204. That is, path unit 202 may select an additional set of communication paths from the one or more additional sets of communication paths based on the policy alignment values (e.g., the one that most aligns to network policy 204). This selected additional set of communication paths may be referred to as the second set of communication paths. In this way, path unit 202 may determine that the second set of communication paths is more aligned with the network policy 204 than the first set of communication paths.

In one or more examples, path unit 202 may take actions to ensure that communication paths (e.g., the network topology) aligns with the selected additional set of communication paths (e.g., the second set of communication paths). For instance, path unit 202 may determine usage of at least one communication port of the at least one satellite device 106 that would result in the spanning tree protocol establishing the second set of communication paths. As an example, path unit 202 may determine how the various communication ports of satellite device 106 should connect, disconnect, or otherwise be utilized so that when the spanning tree protocol is implemented in a second instance the resulting communication paths that the spanning tree protocol determines are the same as the second set of communication paths.

Path unit 202 may output, based on the determination that the second set of communication paths is more aligned with the network policy than the first set of communication paths, one or more commands to modify usage of at least one communication port of at least one satellite device 106A or 106B to cause a second instance of implementation of the spanning tree protocol to establish the second set of communication paths in the network. There may be various examples of commands that path unit 202 may output that are described in more detail below.

One example of a command from path unit 202 may be a command to a satellite device 106 (using whatever management protocol is being employed e.g., 1905.1, SNMP, TR069 etc.) to enable its disabled non-AP station interface or disable its enabled non-AP station interface. This way, the communication port that resulted in the first instance of the STP implementation selecting the first set of communication paths (e.g., the one that is inconsistent with network policy 204) may not be available, and the result may be that the second instance of the STP implementation selects the second set of communication paths (e.g., the one that is consistent with network policy 204).

Another example of a command from path unit 202 may be a command to a satellite device 106 to change the bridge to which its enabled non-AP station interface is mounted, such as in examples where data passes through a main bridge, but includes a stub bridge that can either host the non-AP station interface or no interfaces, and is not part of the STP implementation. This way, the communication port that resulted in the first instance of the STP implementation selecting the first set of communication paths (e.g., the one that is inconsistent with network policy 204) may not be seen as being available for data communication, and the result may be that the second instance of the STP implementation selects the second set of communication paths (e.g., the one that is consistent with network policy 204).

Another example of a command from path unit 202 may be a command to a satellite device 106 to force the enabled non-AP station interface of the satellite device 106 to transition to a different trunking BSS (e.g., transition from current trunking BSS to different trunking BSS). This way, the STP implementation does not consider the enabled non-AP station interface as being part of the network topology. For instance, if usage of the enabled non-AP station interface causes the first instance of the STP implementation to result in the first set of communication paths (e.g., the one that is inconsistent with network policy 204), then by causing the non-AP station interface to be part of a different trunking BSS, the second instance of the STP implementation may not select the non-AP station interface as part of the communication paths, thereby resulting in the second set of communication paths that are better aligned with network policy 204.

Another example of a command from path unit 202 may be a command to a satellite device 106 to ensure that the enabled non-AP station interface of the satellite device 106 remains unassociated to any trunking BSS. Similarly, in this case, the STP implementation does not consider the enabled non-AP station interface as being part of the network topology. For instance, if usage of the enabled non-AP station interface causes the first instance of the STP implementation to result in the first set of communication paths (e.g., the one that is inconsistent with network policy 204), then by causing the non-AP station interface to be unassociated with any trunking BSS, the second instance of the STP implementation may not select the non-AP station interface as part of the communication paths, thereby resulting in the second set of communication paths that are better aligned with network policy 204.

As described above, path unit 202 may be configured to determine one or more additional sets of communication paths (e.g., spanning tree network topologies) in addition to the first set of communication paths (e.g., the spanning tree network topology determined by implementation of the STP). To determine the one or more additional sets of communication paths, path unit 202 may identify communication paths (also called fallow edges) that connect each pair of gateway device 104 and/or satellite devices 106 managed by network controller 108 (e.g., as part of the network controller process). In this context, a fallow edge is a communications path that traverses one or more segments of communication systems 100A and 100B (e.g., the LAN) that, but for actions taken by implementations of the STP, would allow a pair of gateway device 104 and/or satellite devices 106 to mutually exchange data.

For example, in FIGS. 1A and 1B, implementation of the STP resulted in selection of a first set of communications paths that include communication paths 112A and 112B. However, communication path 118 (e.g., Ethernet link) was also available, but was not selected by the STP implementation. In one or more examples, path unit 202 would recognize communication path 118 as a fallow edge because communication path 118 is a communications path that traverses a single LAN segment (e.g., between satellite devices 106A and 106B) that, but for actions taken by implementation of STP, would allow satellite device 106A and satellite device 106B to mutually exchange data.

To identify the fallow edges, in one example, path unit 202 may mine the STP MIB 206. MIB 206 in memory 111 may be distributed across different satellite devices 106, or may be considered as being retrieved from different satellite devices 106 for local storage and usage by path unit 202. MIB 206 of satellite device 106B may store information that lists the identity of each other gateway device 104 and/or satellite devices 106 transmitting bridge protocol data units (BPDUs) received by every interface (e.g., communication ports 110B and 116B of satellite device 106B) along with the interface number on the remote satellite devices 106 or gateway device 104 sourcing those BPDUs. The same would be true for satellite device 106A.

For example, consider the topology shown FIGS. 1A and 1B in which the Ethernet cable (e.g., communication path 118) connects to communication port 116A (i.e., interface 116A) of satellite device 106A and communication port 116B (i.e., interface 116B) of satellite device 106B. In this example, MIB 206 that includes information for satellite device 106B that communication port 116B is getting BPDUs from communication port 116A. Based on this information, plus path unit 202 knowing that communication port 116B is blocked (e.g., based on information from STP unit 200), path unit 202 may determine that a fallow edge exists between communication port 116A and communication port 116B.

Depending on the actual topology, it may be possible that MIB 206 does not reveal all fallow edges, such as where a third party or unmanaged STP-enabled switch is included. In some such examples, path unit 202 may selectively disable and enable various communication ports and determine whether communication is still possible, such as by allowing repeated implementations of the STP protocol. This way, path unit 202 may be able to determine fallow edges such as in examples of third-party or unmanaged STP-enabled switch.

In one or more examples, path unit 202 may determine fallow edges that are feasible. That is, even if there is a fallow edge, but enabling usage of that fallow edge is not possible, then that fallow edge is not feasible. A feasible fallow edge may be considered as a communication path that can be animated. This way, path unit 202 can identify which alternate spanning trees (e.g., additional sets of communication paths) are feasible.

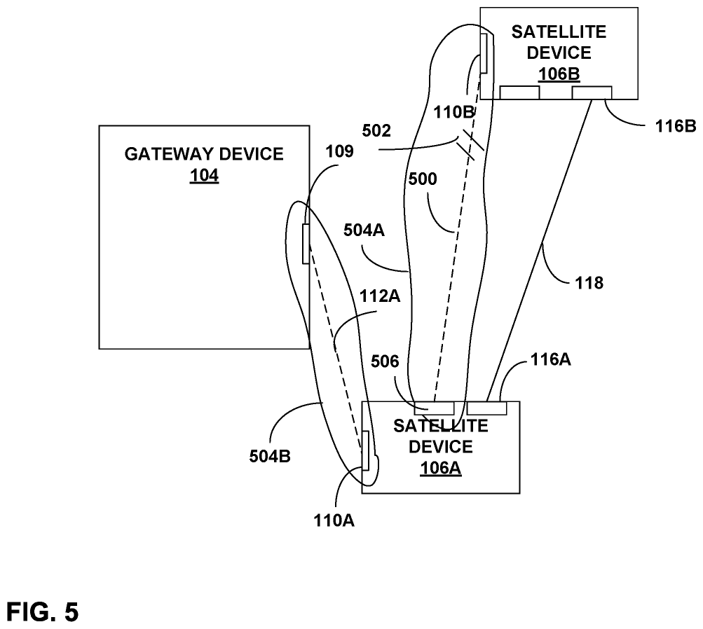

To perform such actions, path unit 202 may emulate STP (specifically the logic STP employs to select the spanning tree) and determine the value of the various parameters on all the satellite devices 106 in the network that feed that tree-selection logic. For example, consider an example in which path unit 202 causes communication port 110B to wirelessly communicate with satellite device 106A (as shown in FIG. 5 and described below). This action may (e.g., will) animate the fallow communication path 118 only if either a) the Root Path Cost of the non-AP station interface (e.g., communication port 506 in FIG. 5) on satellite 106A is less than that of communication port 116B (e.g., Ethernet interface of satellite 106B) or b) the Root Path Costs of non-AP station and Ethernet interfaces (e.g., communication ports 110B and 116B) have same Root Path Cost and the priority of communication port 116B (e.g., Ethernet interface of satellite device 106B) is higher than that of non-AP station interface (e.g., communication port 110B) of satellite device 106B. Accordingly, path unit 202 may determine the value of these parameters plus a collection of other parameters for determining feasible fallow edges. Path unit 202 can obtain this knowledge by either browsing the MIB 206 of each satellite device 106 and/or gateway device 104 or be configured (e.g., by a network management server) with this information.

As described above, path unit 202 may be configured to determine policy alignment values of the one or more additional sets of communication paths (e.g., the feasible fallow edges described above) and the first set of communication paths (e.g., the one determined from the first instance of the implementation of the STP) based on the network policy 204. To determine policy alignment values, path unit 202 may be able to enumerate throughput/capacity of each fallow edge (e.g., each of the additional sets of communication paths) that connects any pair of gateway device 104 and satellite devices 106. After confirming the existence of communication path 118, path unit 202 may continue to mine the STP (and non-STP) MIBs 206 of both satellite 106A and satellite 106B and determine that a) communication port 116A is running 2.5 Gbps full duplex, b) communication port 116B is running 2.5 Gbps full duplex, and c) only communication port 116B is receiving BPDUs from communication port 116A. In this example, these determinations can lead path unit 202 to reasonably conclude that there is 2.5 Gbps of latent capacity between communication port 116A and communication port 116B.

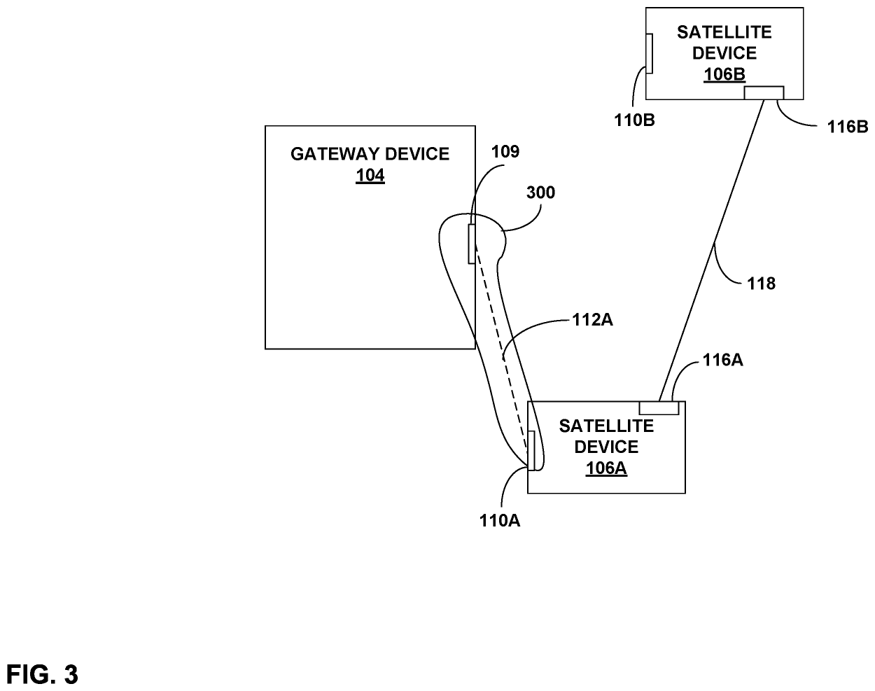

FIG. 3 is a block diagram illustrating an example a modified usage of at least one communication port for spanning tree protocol updating. FIG. 3 illustrates one example of commands that path unit 202 may output commands to to modify usage of at least one communication port of the at least one satellite device, and the result from implementation at least the portion of the spanning tree protocol in a second instance to establish a second set of communication paths in the network based on the modified usage of the communication port. That is, the communication paths illustrated in FIG. 3 may better align (i.e., be consistent) with network policy 204 than those of FIGS. 1A and 1B.

In FIG. 3, path unit 202 may command satellite device 106B to disable the non-AP-station interface of satellite device 106B. The result of this may be that the second instance of implementation of the STP results in communication path 118 being enabled. In FIG. 3, path unit 202 may be configured to output the one or more commands to enable a disabled communication port of the at least one satellite device or disable an enabled communication port communication port of the at least one satellite device. For instance, in FIG. 3, path unit 202 may output one or more commands to satellite device 106B to disable communication port 110B. In this case, there may be one path between gateway device 104 and satellite device 106B, and that is through communication path 118. In this manner, path unit 202 may modify usage of at least one of the communication ports on at least one of the satellite devices 106. Accordingly, in a second instance of implementation of the STP, the result may be that the second set of communication paths includes communication path 118, and communication path 112B is no longer available.

As another example with respect to FIG. 3, path unit 202 may force the non-AP station interface (e.g., communication port 110B) of satellite device 106B to disassociate from gateway device 104 and remain unassociated. For instance, satellite device 106B is not part of trunking BSS 300. This can be accomplished with a variety of techniques including a) sending a message directly to satellite device 106B that prompts satellite device 106B to keep its non-AP station function disassociated or b) sending one message to the gateway device 104 that prompts gateway device 104 to de-authenticate satellite device 106B and thereafter prevent satellite device 106B from re-associating to the trunking BSS of gateway device 104 and another message to satellite device 106A that prompts satellite device 106A to prevent satellite 106B from associating to the trunking BSS of satellite device 106A.

Accordingly, in one example, path unit 202 may be configured to output the one or more commands to force an enabled communication port (e.g., communication port 116B) of the at least one satellite device (e.g., satellite device 106B) to remain unassociated with any trunking basic service set (BSS). In this manner, path unit 202 may modify usage of at least one of the communication ports on at least one of the satellite devices 106. Accordingly, during a second implementation of the STP, communication port 116B may not be available, and communication path 118 would be selected as being part of the second set of communication paths (e.g., the ones that are consistent with network policy 204).

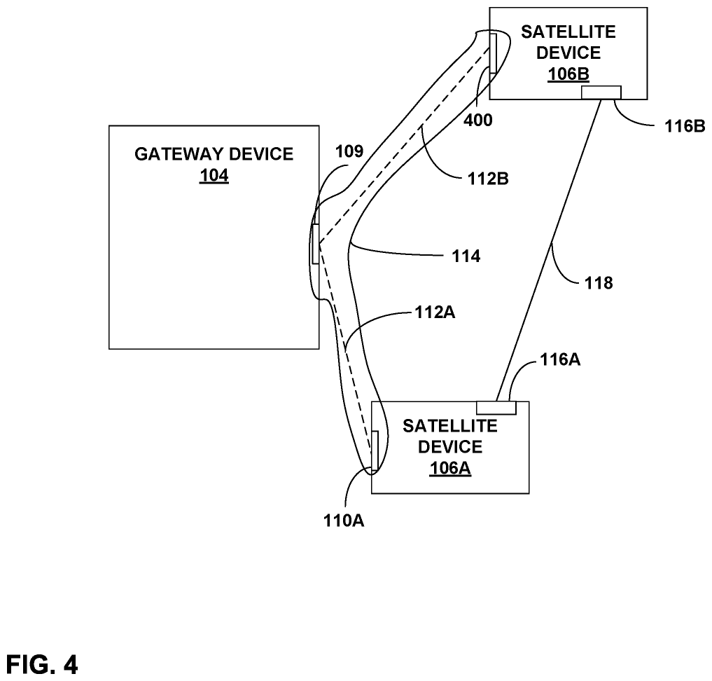

FIG. 4 is a block diagram illustrating another example a modified usage of at least one communication port for spanning tree protocol updating. In one example, path unit 202 may command satellite 106B to move the non-AP-station interface of command satellite 106B from its main bridge to its stub bridge. In this manner, path unit 202 may modify usage of at least one of the communication ports on at least one of the satellite devices 106. For example, as illustrated in FIG. 4, what was communication port 110B connected to main bridge is now communication port 400 connected to stub bridge. The stub bridge may not be a bridge used as part of STP implementation, and therefore, the second instance of the STP may determine that communication path 118 should be part of the second set of communication paths for communicating between satellite device 106B and gateway device 104.

FIG. 5 is a block diagram illustrating another example a modified usage of at least one communication port for spanning tree protocol updating. Path unit 202 may command satellite device 106B to force the non-AP station interface of satellite device 106B to associate to the trunking BSS emanated by satellite device 106A. For example, there is trunking BSS 504B and trunking BSS 504A of satellite device 106A. In this example, path unit 202 may output the one or more commands to force an enabled communication port (e.g., communication port 110B) of the at least one satellite device 106B to transition from a current trunking basic service set (BSS) (e.g., trunking BSS 114) to a different trunking BSS (e.g., trunking BSS 504A).

The example of FIG. 5 may be available if path loss between satellite device 106B and satellite device 106A is such that an association can be established. In one or more examples, the Root Path Cost of non-AP station interfaces is higher than that of Ethernet interfaces. For instance, communication path between communication port 506 of satellite device 106A and communication port 110B of satellite device 106B may be relatively low (e.g., 400 Mbps). In this case, in a second instance of the implementation of the STP, it may be that the Root Path Cost through communication path 500 is greater than through communication path 118. Therefore, the STP may (e.g., will) block communication path 500 shown with blocking connection 502, and select communication path 118 as being part of the second set of communication paths that better align with network policy 204.

Path unit 202 can force satellite device 106B to transition communication port 110B using a variety of techniques including a) sending a message to the gateway device 104 that prompts gateway device 104 to send an 802.11v BSS transition management (BTM) to satellite device 106B that asks satellite device 106B to transition to trunking BSS of satellite device 106A (e.g., trunking BSS 504A), b) sending a message directly to satellite device 106B that prompts satellite device 106B transition to trunking BSS 504A of satellite device 106A, and c) sending a message to the gateway device 104 that prompts gateway device 104 to de-authenticate satellite device 106B and thereafter prevent satellite device 106B from re-associating to trunking BSS 504B. In this case, satellite device 106B would autonomously associate to trunking BSS 504A of satellite device 106A.

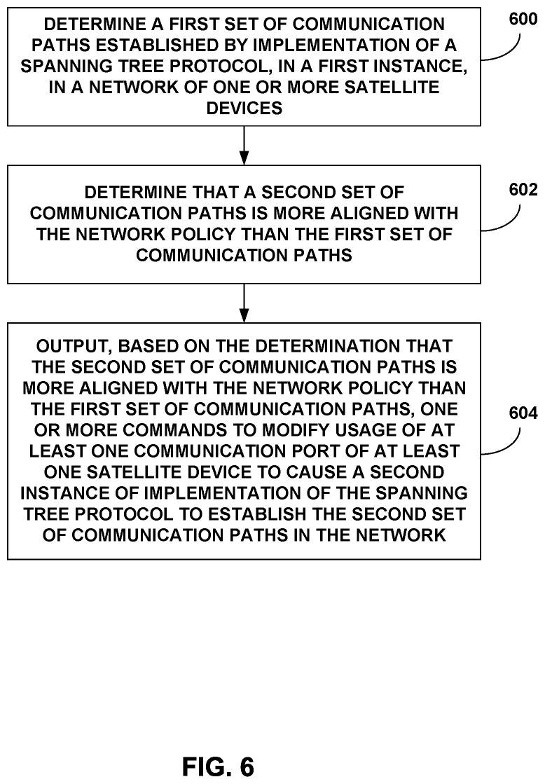

FIG. 6 is a flowchart illustrating example techniques, in accordance with one or more aspects of this disclosure. STP unit 200 may determine a first set of communication paths established by implementation of a spanning tree protocol, in a first instance, in a network of one or more satellite devices 106A and 106B (600). For instance, gateway device 104 and/or satellite devices 106A and 106B may together (e.g., in a distributed manner) implement a first instance of the spanning tree protocol. The result of which may be the first set of communication paths. STP unit 200 may receive information about the manner in which the first set of communication paths are connected to determine the first set of communication paths established by implementation of a spanning tree protocol, in a first instance, in a network of one or more satellite devices 106A and 106B.

Path unit 202 determine that a second set of communication paths is more aligned with the network policy than the first set of communication paths (602). For instance, path unit 202 may determine that the first set of communication paths is inconsistent with the network policy 204. For example, path unit 202 may determine one or more additional sets of communication paths in addition to the first set of communication paths, and determine policy alignment values of the one or more additional sets of communication paths and the first set of communication paths based on the network policy 204. For instance, path unit 202 may determine, as the policy alignment values, how different each of the sets of communication paths are from network policy 204.

In some examples, to determine that the second set of communication paths is more aligned with the network policy 204 than the first set of communication paths, path unit 202 may be configured to compare the respective policy alignment values of the one or more additional sets of communication paths, and determine that the second set of communication paths, which is one of the one or more additional sets of communication paths, is more aligned with the network policy 204 than the first set of communication paths based on the comparison. For example, if there is an additional communication path that better aligns (e.g., is more consistent) with the network policy 204 than the first set of communication paths (e.g., as determined by first instance of implementation of STP), then path unit 202 may determine that the first set of communication paths does not align (e.g., is inconsistent) with network policy 204.

Path unit 202 may output, based on the determination that the second set of communication paths is more aligned with the network policy than the first set of communication paths, one or more commands to modify usage of at least one communication port of at least one satellite device to cause a second instance of implementation of the spanning tree protocol to establish the second set of communication paths in the network (604). In some examples, path unit 202 may determine usage of the at least one communication port of the at least one satellite device that would result in the spanning tree protocol establishing the second set of communication paths (e.g., some non-limiting examples of which are illustrated and described in FIGS. 3-5). To output the one or more commands, path unit 202 may be configured to output the one or more commands based on the determined usage of the at least one communication port.

For example, to output the one or more commands, path unit 202 may be configured to output the one or more commands to enable a disabled communication port of the at least one satellite device or disable an enabled communication port communication port of the at least one satellite device (e.g., as shown in FIG. 3). As another example, to output the one or commands, path unit 202 may be configured to output the one or more commands to force an enabled communication port of the at least one satellite device to remain unassociated with any trunking basic service set (BSS) (e.g., as also shown in FIG. 3).

As another example, to output the one or more commands, path unit 202 may be configured to output the one or more commands to change a bridge to which the at least communication port of the at least one satellite device is mounted (e.g., as shown in FIG. 4). As another example, to output the one or commands, path unit 202 may be configured to output the one or more commands to force an enabled communication port of the at least one satellite device to transition from a current trunking basic service set (BSS) to a different trunking BSS (e.g., as shown in FIG. 5).

The following describes example techniques in accordance with one or more examples described in this disclosure. The example techniques may be utilized together or separately.

Example 1. A communication system comprising: memory configured to store a network policy; and a network controller, implemented in circuitry, coupled to the memory and configured to: determine a first set of communication paths established by implementation of a spanning tree protocol, in a first instance, in a network of one or more satellite devices; determine that a second set of communication paths is more aligned with the network policy than the first set of communication paths; and output, based on the determination that the second set of communication paths is more aligned with the network policy than the first set of communication paths, one or more commands to modify usage of at least one communication port of at least one satellite device to cause a second instance of implementation of the spanning tree protocol to establish the second set of communication paths in the network.

Example 2. The communication system of example 1, wherein to determine that the second set of communication paths is more aligned with the network policy than the first set of communication paths, the network controller is configured to determine that the second set of communication paths is more aligned with the network policy by a sufficient threshold than the first set of communication paths.

Example 3. The communication system of any of examples 1 and 2, wherein the network controller is configured to: determine one or more additional sets of communication paths in addition to the first set of communication paths; and determine policy alignment values of the one or more additional sets of communication paths and the first set of communication paths based on the network policy, wherein to determine that the second set of communication paths is more aligned with the network policy than the first set of communication paths, the network controller is configured to: compare the respective policy alignment values of the one or more additional sets of communication paths; and determine that the second set of communication paths, which is one of the one or more additional sets of communication paths, is more aligned with the network policy than the first set of communication paths based on the comparison, wherein the network controller is configured to determine usage of the at least one communication port of the at least one satellite device that would result in the spanning tree protocol establishing the second set of communication paths, and wherein to output the one or more commands, the network controller is configured to output the one or more commands based on the determined usage of the at least one communication port.

Example 4. The communication system of any of examples 1-3, wherein to output the one or more commands, the network controller is configured to output the one or more commands to enable a disabled communication port of the at least one satellite device or disable an enabled communication port of the at least one satellite device.

Example 5. The communication system of any of examples 1-4, wherein to output the one or more commands, the network controller is configured to output the one or more commands to change a bridge to which the at least communication port of the at least one satellite device is mounted.

Example 6. The communication system of any of examples 1-5, wherein to output the one or commands, the network controller is configured to output the one or more commands to force an enabled communication port of the at least one satellite device to transition from a current trunking basic service set (BSS) to a different trunking BSS.

Example 7. The communication system of any of examples 1-6, wherein to output the one or commands, the network controller is configured to output the one or more commands to force an enabled communication port of the at least one satellite device to remain unassociated with any trunking basic service set (BSS).

Example 8. The communication system of any of examples 1-7, wherein to output the one or more commands, the network controller is configured to output the one or more commands without modifying parameters of the spanning tree protocol.

Example 9. The communication system of any of examples 1-8, wherein the network policy comprises maximizing throughput between gateway and the satellite devices.

Example 10. The communication system of any of examples 1-9, wherein the network comprises a local area network (LAN).

Example 11. A method comprising: determining a first set of communication paths established by implementation of a spanning tree protocol, in a first instance, in a network of one or more satellite devices; determining that a second set of communication paths is more aligned with a network policy than the first set of communication paths; and outputting, based on the determination that the second set of communication paths is more aligned with the network policy than the first set of communication paths, one or more commands to modify usage of at least one communication port of at least one satellite device to cause a second instance of implementation of the spanning tree protocol to establish the second set of communication paths in the network.

Example 12. The method of example 11, wherein determining that the second set of communication paths is more aligned with the network policy than the first set of communication paths comprises determining that the second set of communication paths is more aligned with the network policy by a sufficient threshold than the first set of communication paths.

Example 13. The method of any of examples 11 and 12, further comprising: determining one or more additional sets of communication paths in addition to the first set of communication paths; and determining policy alignment values of the one or more additional sets of communication paths and the first set of communication paths based on the network policy, wherein determining that the second set of communication paths is more aligned with the network policy than the first set of communication paths comprises: comparing the respective policy alignment values of the one or more additional sets of communication paths; and determining that the second set of communication paths, which is one of the one or more additional sets of communication paths, is more aligned with the network policy than the first set of communication paths based on the comparison, the method further comprising determining usage of the at least one communication port of the at least one satellite device that would result in the spanning tree protocol establishing the second set of communication paths, and wherein outputting the one or more commands comprises outputting the one or more commands based on the determined usage of the at least one communication port.

Example 14. The method of any of examples 11-13, wherein outputting the one or more commands comprises outputting the one or more commands to enable a disabled communication port of the at least one satellite device or disable an enabled communication port of the at least one satellite device.

Example 15. The method of any of examples 11-14, wherein outputting the one or more commands comprises outputting the one or more commands to change a bridge to which the at least communication port of the at least one satellite device is mounted.

Example 16. The method of any of examples 11-15, wherein outputting the one or more commands comprises outputting the one or more commands to force an enabled communication port of the at least one satellite device to transition from a current trunking basic service set (BSS) to a different trunking BSS.

Example 17. The method of any of examples 11-16, wherein outputting the one or more commands comprises outputting the one or more commands to force an enabled communication port of the at least one satellite device to remain unassociated with any trunking basic service set (BSS).

Example 18. The method of any of examples 11-17, wherein outputting the one or more commands comprises outputting the one or more commands without modifying parameters of the spanning tree protocol.

Example 19. The method of any of examples 11-18, wherein the network policy comprises maximizing throughput between gateway and the satellite devices.

Example 20. A computer-readable storage medium storing instructions thereon that when executed cause one or more processors to: determine a first set of communication paths established by implementation of a spanning tree protocol, in a first instance, in a network of one or more satellite devices; determine that a second set of communication paths is more aligned with a network policy than the first set of communication paths; and output, based on the determination that the second set of communication paths is more aligned with the network policy than the first set of communication paths, one or more commands to modify usage of at least one communication port of at least one satellite device to cause a second instance of implementation of the spanning tree protocol to establish the second set of communication paths in the network.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the term “processor” or “controller” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including an IC or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A communication system comprising:
memory configured to store a network policy; and
a network controller, implemented in circuitry, coupled to the memory and configured to:
determine a first set of communication paths established by implementation of a spanning tree protocol, in a first instance, in a network of one or more satellite devices;
determine that a second set of communication paths is more aligned with the network policy than the first set of communication paths; and
output, based on the determination that the second set of communication paths is more aligned with the network policy than the first set of communication paths, one or more commands to modify usage of at least one communication port of at least one satellite device to cause a second instance of implementation of the spanning tree protocol to establish the second set of communication paths in the network.

2. The communication system of claim 1, wherein to determine that the second set of communication paths is more aligned with the network policy than the first set of communication paths, the network controller is configured to determine that the second set of communication paths is more aligned with the network policy by a sufficient threshold than the first set of communication paths.

3. The communication system of claim 1, wherein the network controller is configured to:
determine one or more additional sets of communication paths in addition to the first set of communication paths; and
determine policy alignment values of the one or more additional sets of communication paths and the first set of communication paths based on the network policy,
wherein to determine that the second set of communication paths is more aligned with the network policy than the first set of communication paths, the network controller is configured to:
compare the respective policy alignment values of the one or more additional sets of communication paths; and
determine that the second set of communication paths, which is one of the one or more additional sets of communication paths, is more aligned with the network policy than the first set of communication paths based on the comparison,
wherein the network controller is configured to determine usage of the at least one communication port of the at least one satellite device that would result in the spanning tree protocol establishing the second set of communication paths, and
wherein to output the one or more commands, the network controller is configured to output the one or more commands based on the determined usage of the at least one communication port.

4. The communication system of claim 1, wherein to output the one or more commands, the network controller is configured to output the one or more commands to enable a disabled communication port of the at least one satellite device or disable an enabled communication port of the at least one satellite device.

5. The communication system of claim 1, wherein to output the one or more commands, the network controller is configured to output the one or more commands to change a bridge to which the at least communication port of the at least one satellite device is mounted.

6. The communication system of claim 1, wherein to output the one or commands, the network controller is configured to output the one or more commands to force an enabled communication port of the at least one satellite device to transition from a current trunking basic service set (BSS) to a different trunking BSS.

7. The communication system of claim 1, wherein to output the one or commands, the network controller is configured to output the one or more commands to force an enabled communication port of the at least one satellite device to remain unassociated with any trunking basic service set (BSS).

8. The communication system of claim 1, wherein to output the one or more commands, the network controller is configured to output the one or more commands without modifying parameters of the spanning tree protocol.

9. The communication system of claim 1, wherein the network policy comprises maximizing throughput between gateway and the satellite devices.

10. The communication system of claim 1, wherein the network comprises a local area network (LAN).

11. A method comprising:
determining a first set of communication paths established by implementation of a spanning tree protocol, in a first instance, in a network of one or more satellite devices;
determining that a second set of communication paths is more aligned with a network policy than the first set of communication paths; and
outputting, based on the determination that the second set of communication paths is more aligned with the network policy than the first set of communication paths, one or more commands to modify usage of at least one communication port of at least one satellite device to cause a second instance of implementation of the spanning tree protocol to establish the second set of communication paths in the network.

12. The method of claim 11, wherein determining that the second set of communication paths is more aligned with the network policy than the first set of communication paths comprises determining that the second set of communication paths is more aligned with the network policy by a sufficient threshold than the first set of communication paths.

13. The method of claim 11, further comprising:
determining one or more additional sets of communication paths in addition to the first set of communication paths; and
determining policy alignment values of the one or more additional sets of communication paths and the first set of communication paths based on the network policy,
wherein determining that the second set of communication paths is more aligned with the network policy than the first set of communication paths comprises:
comparing the respective policy alignment values of the one or more additional sets of communication paths; and
determining that the second set of communication paths, which is one of the one or more additional sets of communication paths, is more aligned with the network policy than the first set of communication paths based on the comparison,
the method further comprising determining usage of the at least one communication port of the at least one satellite device that would result in the spanning tree protocol establishing the second set of communication paths, and
wherein outputting the one or more commands comprises outputting the one or more commands based on the determined usage of the at least one communication port.

14. The method of claim 11, wherein outputting the one or more commands comprises outputting the one or more commands to enable a disabled communication port of the at least one satellite device or disable an enabled communication port of the at least one satellite device.

15. The method of claim 11, wherein outputting the one or more commands comprises outputting the one or more commands to change a bridge to which the at least communication port of the at least one satellite device is mounted.

16. The method of claim 11, wherein outputting the one or more commands comprises outputting the one or more commands to force an enabled communication port of the at least one satellite device to transition from a current trunking basic service set (BSS) to a different trunking BSS.

17. The method of claim 11, wherein outputting the one or more commands comprises outputting the one or more commands to force an enabled communication port of the at least one satellite device to remain unassociated with any trunking basic service set (BSS).

18. The method of claim 11, wherein outputting the one or more commands comprises outputting the one or more commands without modifying parameters of the spanning tree protocol.

19. The method of claim 11, wherein the network policy comprises maximizing throughput between gateway and the satellite devices.

20. A computer-readable storage medium storing instructions thereon that when executed cause one or more processors to:
determine a first set of communication paths established by implementation of a spanning tree protocol, in a first instance, in a network of one or more satellite devices;
determine that a second set of communication paths is more aligned with a network policy than the first set of communication paths; and
output, based on the determination that the second set of communication paths is more aligned with the network policy than the first set of communication paths, one or more commands to modify usage of at least one communication port of at least one satellite device to cause a second instance of implementation of the spanning tree protocol to establish the second set of communication paths in the network.
